(19) United States
(12) Patent Application Publication
(10) Pub. No.: US 2023/0387442 A1
(43) Pub. Date: Nov. 30, 2023

(54) FUEL CELL SYSTEM FOR A VEHICLE

(71) Applicant: Robert Bosch GmbH, Stuttgart (DE)

(72) Inventors: Dirk Schnittger, Ludwigsburg (DE); Rolf-Peter Essling, Reudern (DE); Tobias Korte, Walddorfhaeslach (DE)

(21) Appl. No.: 18/249,636

(22) PCT Filed: Oct. 20, 2021
(86) PCT No.: PCT/EP2021/079041

§ 371 Date: Apr. 19, 2023

(30) Foreign Application Priority Data
Oct. 28, 2020 (DE) 10 2020 213 523.1

(51) Int. Cl. H01M 8/2475; H01M 8/249; B60L 50/71

(52) U.S. Cl. CPC H01M 8/2475; H01M 8/249; B60L 50/71; H01M 2250/20

(57) ABSTRACT

The invention relates to a fuel cell system (100) for a vehicle (F), comprising a vehicle frame or vehicle body part, having: at least one fuel cell module (M1, M2) and a support structure (10) for supporting the fuel cell system (100) on the vehicle frame or the vehicle body part, wherein the support structure (10) has at least one inner component support (13) relative to the at least one fuel cell module (M1, M2), submodules of the at least one fuel cell module (MI, M2) are connected to the at least one inner component support (13), and the at least one component support (13) has at least one securing interface (11, 12) in order to secure the fuel cell system (100) on the vehicle frame or the vehicle body part.

### BACKGROUND

The invention relates to a modularly designed fuel cell system for a vehicle, which can be supported on a vehicle frame or a vehicle body part. Further, the invention relates to a corresponding vehicle.

Devices for attaching fuel cell systems to the vehicle are generally known. Mostly, such devices are embodied separately from the fuel cell systems. Often, such devices have box-shaped housings that completely enclose the fuel cell system. On the exterior of the housings, known devices comprise elements for attaching fuel cell systems to the vehicle, for example to a vehicle frame.

### SUMMARY

According to a first aspect, the invention provides an improved, modularly designed fuel cell system, which in particular has at least two fuel cell modules, which can be reliably supported on a vehicle frame or a vehicle body part simply and without much effort or many additional connecting elements, having the features of the independent device claim. In addition, according to a second aspect, the invention provides a corresponding vehicle having the features of the independent device claim.

Further advantages, features, and details of the invention arise from the subclaims, the description, and the drawings. Features and details described in connection with the different aspects according to the invention also apply in connection with the other aspects according to the invention, and respectively vice versa, so that relative to the disclosure, mutual reference to the individual aspects of the invention is or can always be made.

According to the first aspect, the invention provides a fuel cell system for a vehicle having a vehicle frame or vehicle body part, having: at least one, in particular at least two, fuel cell module(s) and a support structure for supporting the fuel cell system on the vehicle frame or vehicle body part. The invention provides that the support structure has at least one inner component support relative to the at least one fuel cell module, wherein submodules of the at least one fuel cell module are connected to the at least one inner component support, preferably releasably, e.g., in a form-fit or force-fit manner, and wherein the at least one component support has at least one securing interface, in order to secure the fuel cell system, directly or indirectly, e.g., via further connecting parts, such as transverse beams, on the vehicle frame or the vehicle body part, preferably releasably, e.g., in a form-fit or force-fit manner.

The fuel cell modules (or simply modules) in the sense of the invention can each comprise a submodule in the form of a fuel cell stack having a plurality of stacked repeat units in the form of individual fuel cells, preferably PEM fuel cells, which can be accommodated in a housing.

The fuel cell modules in the sense of the invention can further comprise the following submodules:
submodule for oxidizer supply and exhaust gas discharge, such as air compressor, air cooler, humidifier, air shut-off valves, etc.
submodule for fuel supply, such as hydrogen dosing valve, water separator, hydrogen recirculation fan, jet pump, etc.
submodule for control electronics,
submodule for electronic components, and
submodule for cooling supply, such as coolant pump, valves for controlling and regulating coolant flows, heat exchangers, coolant hoses, etc.

The fuel cell system according to the invention may advantageously be used for mobile applications, e.g., in motor vehicles, or for stationary applications, e.g., in generator systems. In the latter case, instead of a vehicle frame, a stationary frame structure can be used in order to support the fuel cell system thereon.

The idea of the invention is that the fuel cell modules accommodate the at least one inner component support of the support structure within the modules. The support structure in the sense of the invention forms a post structure for the fuel cell modules. The support structure advantageously allows the fuel cell modules according to the invention to be designed in an open manner and to be supported on the vehicle without a completely enclosed housing.

In the context of the invention, it is conceivable that the at least one inner component support of the support structure can be designed continuously through all modules of the fuel cell system. It is conceivable that the continuous inner component support of the support structure can be formed by individual, firmly connected component supports for each module of the fuel cell system.

In the context of the invention, it is further conceivable that each module of the fuel cell system can form an individually manageable module unit having the corresponding elements of the support structure. A single inner component support can be provided for each module of the fuel cell system.

In principle, it is conceivable in the context of the invention that the at least one (continuous or single) inner component support can configured in one piece and/or materially uniform and/or monolithically. However, it is also conceivable that the at least one (continuous or single) inner component support can be compiled from a plurality of separate parts, which can in turn be joined together in a materially locking manner, in particular by welding, or in a form-fit or force-fit manner, in particular by screwing, latching, and/or clamping.

The submodules and/or components of the fuel cell modules can be externally connected to the at least one inner component support (possibly with additional brackets). According to the invention, it is advantageous that only the at least one inner component support needs to be implemented for securing the submodules and/or components of the fuel cell modules. In other words, the submodules and/or components of the fuel cell modules are not supported directly on the vehicle, but rather merely via the inner component support.

Several advantages arise from the invention:
improved accessibility to the submodules and/or components of the fuel cell modules of the fuel cell system,
low manufacturing costs,
simple construction of the support structure,
simple assembly of the support structure on the vehicle,
a more service-friendly concept/better maintainability for the fuel cell system submodules and/or components,
low complexity, smaller number of components, lower cost of fuel cell system,
high robustness against mechanical loads of the fuel cell system,
high flexibility in adapting the fuel cell system to different spaces and different applications (because the exterior of the fuel cell system is not limited by a housing and thus can be more easily adjusted),
low weight, compact design, small space requirements in the vehicle, high power density of the fuel cell system,
robust thermal design due to improved ventilation of the fuel cell system components,
robust thermal design due to the more efficient heat radiation (heat radiation is not reflected by the outer post),
open design also reduces, if not minimizes, the risk of H2 concentration formation.

Further, in a fuel cell system, the invention can provide that the at least one inner component support has only one continuous inner component support relative to all fuel cell modules in order to support the fuel cell system with all fuel cell modules simultaneously on the vehicle frame or the vehicle body part. In this way, a compact fuel cell system can be provided. The mechanical loads of the fuel cell modules can be transferred to the continuous component support and passed on directly or indirectly at the vehicle frame or vehicle body.

Furthermore, in a fuel cell system, the invention can provide that the continuous component support has at least one connection, in particular a material-locking connection, for example a welded or a soldered connection, between at least two modules of the fuel cell system. Wherein the connection point is a seam, or a form-fit or force-fit connection point, wherein screwed, positively-locked, or riveted component support assemblies are possible. Thus, in a simple manner, a continuous component support that is on the inside relative to a plurality of modules of the fuel cell system can be provided.

Furthermore, in a fuel cell system, the invention can provide that the at least one inner component support has a single continuous inner component support for each fuel cell module of the fuel cell system in order to support the respective fuel cell module of the fuel cell system individually on the vehicle frame or the vehicle body part. In this way, an individual manageability of the modules can be provided. Thus, greater flexibility in assembling the fuel cell system from multiple modules can be ensured. The mass forces of the respective fuel cell modules can be discharged directly or indirectly on the vehicle frame via the individual inner component supports. This leads to a reduced mechanical load on the individual inner component supports.

In addition, the invention can provide in a fuel cell system that the at least one inner component support is configured in one piece and/or materially uniform and/or monolithically, or that the at least one inner component support is made from a plurality of parts, which can be joined together in a materially locking manner, for example by welding, or in a form-fit or force-fit manner, in particular by screwing, latching, and/or clamping. In this way, a flexible design of the at least one inner component support can be provided according to desire, concept, or feasibility.

In addition, in a fuel cell system, the invention can provide that the at least one component support has a profile that is closed in cross-section and in particular O-shaped. Thus, improved crash safety and/or impact dampening can be provided by the component support.

In addition, it is conceivable that the at least one component support has a profile that is open in cross-section and in particular Z-shaped, T-shaped, C-shaped, or U-shaped. Thus, the advantage can be achieved that the component support can provide a place for the submodules and/or components of the fuel cell modules to be arranged.

In addition, in a fuel cell system, the invention can provide that the submodules of the at least one fuel cell module are releasably connected to the at least one inner component support, for example in a form-fit or force-fit manner. Thus, better maintainability and/or replacement of the submodules and/or components of the at least one fuel cell module can be enabled.

Further, in a fuel cell system, the invention can provide that the support structure has a first transverse beam and a second transverse beam for supporting the at least one fuel cell module respectively on the front and rear of the vehicle frame or on the vehicle body part, wherein, in particular, the at least one inner component support is arranged so as to support the at least one fuel cell module on the first transverse carrier and on the second transverse carrier. In addition, it is further conceivable that the first transverse beam and the second transverse beam each comprise at least one securing interface for securing the first transverse beam and the second transverse beam to the vehicle frame or a vehicle body part, preferably releasably, e.g., in a form-fit or force-fit manner. In this way, a support structure can be provided that can include finished components of the vehicle frame.

Furthermore, according to the second aspect, the invention provides a vehicle having a vehicle frame or vehicle body part and a fuel cell system, which can be embodied as described above, and which can be arranged on, in particular, supported by, the vehicle frame or the vehicle body part. In doing so, the same advantages can be achieved as described above in connection with the fuel cell system according to the invention. In the present case, reference to these advantages is made in full. It is further conceivable that the vehicle frame can comprise a first longitudinal beam and a second longitudinal beam, and/or that the vehicle frame can comprise a first transverse beam and a second transverse beam, which can in particular be configured as parts of the support structure.

### BRIEF DESCRIPTION OF THE DRAWINGS

Furthermore, the invention is shown in greater detail with reference to the figures. It should be noted that the figures are of a descriptive nature only and are not intended to restrict the invention in any way.

The figures show:

FIG. 1 a possible fuel cell system in the sense of the invention in a top plan view and in a schematic cross-sectional view,

FIG. 2 a further possible fuel cell system in the sense of the invention in a top plan view and in a schematic cross-sectional view, and

FIG. 3 yet another possible fuel cell system in the sense of the invention in a top plan view and in a schematic cross-sectional view.

### DETAILED DESCRIPTION

In the various figures, like parts are always given the same reference numerals, for which reason they are usually only described once.

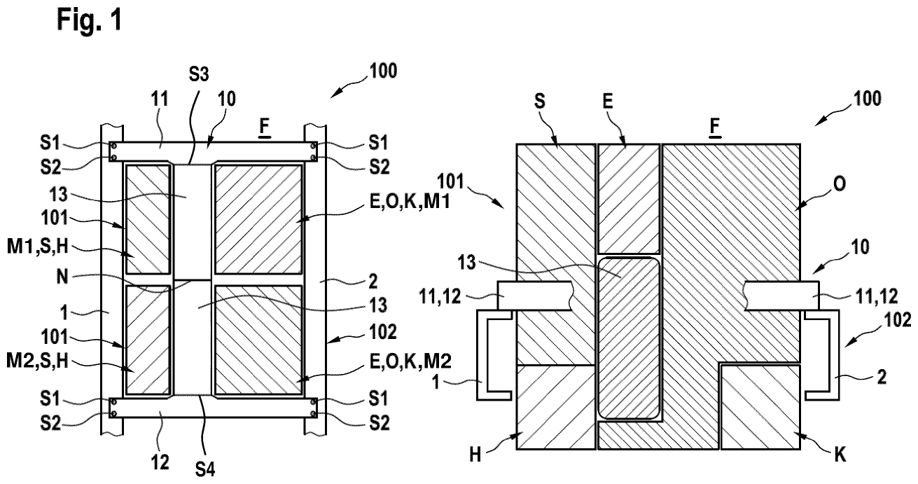

FIGS. 1 to 3 each show a fuel cell system 100 in the sense of the invention, which is provided for a vehicle F having a vehicle frame or a vehicle body part.

The fuel cell system 100 according to the invention can comprise the following elements: at least one fuel cell module M1, M2 and a support structure 10 for supporting the fuel cell system 100 on the vehicle frame or body part, wherein the support structure 10 has at least one inner component support 13 relative to the at least one fuel cell module M1, M2, wherein submodules of the at least one fuel cell module M1, M2 are connected to the at least one inner component support 13, and wherein the at least one component support 13 has at least one securing interface S3, S4, in order to secure the fuel cell system 100, directly or indirectly, e.g., via further connecting parts, on the vehicle frame or vehicle body part, preferably releasably, for example in a form-fit and/or force-fit manner. The connecting parts can be, for example, transverse beams 11, 12.

The figures show two modules M1, M2 in the context of the fuel cell system 101 merely by way of example, wherein the fuel cell system 101 can also comprise a plurality, for example three, four, or even more, of modules M1, M2.

The fuel cell modules M1, M2 or simply modules M1, M2 can comprise the following submodules S, O, H, E, K:
submodule S in the form of a fuel cell stack,
submodule O for oxidizer supply,
submodule H for fuel supply,
submodule E for control electronics, and
submodule K for cooling supply.

The at least one securing interface 11, 12 can be configured in the form of pre-mounted screws, rivets, latching elements, clips, or the like, for example. The figures show by way of example two securing interfaces 11, 12 at each end of the at least one inner component support 13.

According to the invention, the fuel cell modules M1, M2 accommodate the at least one inner component support 13 of the support structure 10 within the modules M1, M2. The support structure 10 thus forms a post structure for the fuel cell modules M1, M2. The support structure 10 allows the fuel cell modules M1, M2 according to the invention to be designed in an open manner and to be supported on the vehicle F without a completely enclosed housing.

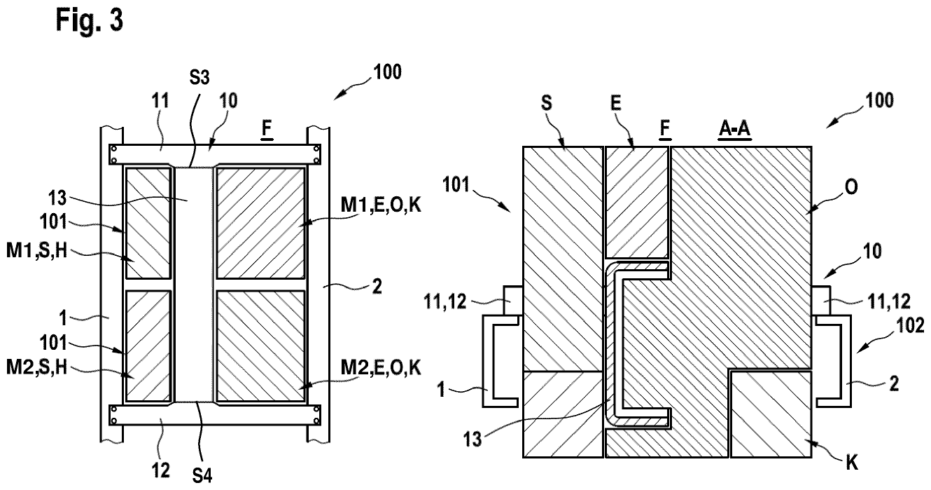

As shown in FIGS. 1 and 3, the at least one inner component support 13 of the support structure 10 can extend continuously through all modules M1, M2 of the fuel cell system 100. According to the embodiment of FIG. 1, it is possible that, between the modules M1, M2, the at least one inner component support 13 can comprise a connection point N, wherein the connection point is a seam or a force-fit or form-fit connection point N.

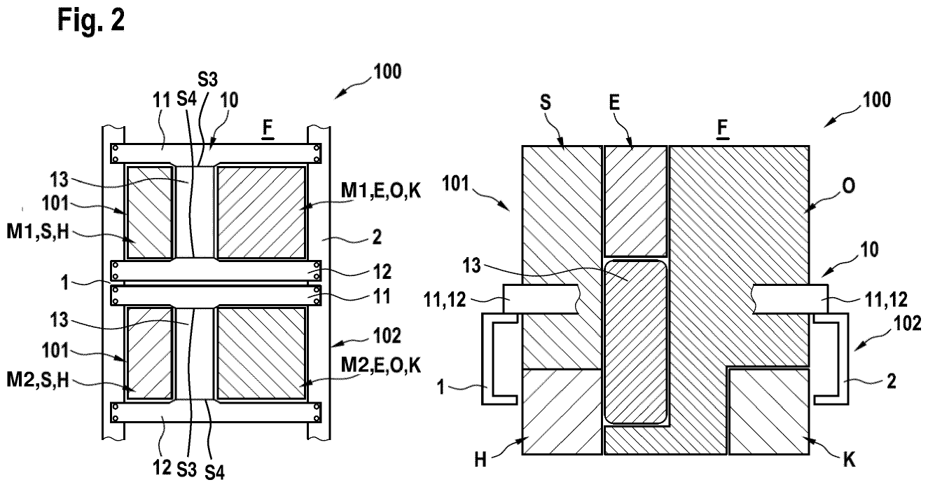

As shown in FIG. 2, each module M1, M2 of the fuel cell system 100 can form an individually manageable module unit with the corresponding elements of the support structure 10. A single inner component support 13 can be provided for each module M1, M2 of the fuel cell system 100.

In the context of the invention, it is conceivable that the at least one (continuous or single) inner component support 13 can be configured in one piece and/or materially uniform and/or monolithically.

In addition, it is conceivable in the context of the invention that the at least one (continuous or single) inner component support 13 can be compiled from a plurality of separate parts, which can in turn be joined together in a materially locking manner, in particular by welding, or in a form-fit or force-fit manner, in particular by screwing, latching, and/or clamping.

The submodules S, O, H, E, K and/or components of the modules M1, M2 can be connected (if necessary with additional brackets), e.g., releasably, to the at least one inner component support 13, e.g., in a form-fit or force-fit manner.

The invention provides that only the at least one inner component support 13 needs to be implemented for securing the submodules S, O, H, E, K and/or components of the fuel cell modules M1, M2 on the vehicle F. The submodules S, O, H, E, K and/or components of the fuel cell modules M1, M2 are not supported directly on the vehicle frame or on the vehicle body part, but indirectly via the at least one inner component support 13 on the vehicle F.

In the context of the invention, it is conceivable that the at least one component support 13 can have a profile that is closed in cross-section, in particular O-shaped (indicated in FIGS. 1 and 2), in order to provide, for example, improved crash safety and/or shock absorption through the component support.

As FIG. 3 implies, it is conceivable in the context of the invention that the at least one component support 13 can have a profile that is open in cross-section, in particular Z-shaped, T-shaped, preferably C-shaped or U-shaped, in order to create space, for example, within the at least one component support 13, for arranging the components and/or submodules S, O, H, E, K of the fuel cell modules M1, M2.

The vehicle F according to the invention is not shown in FIGS. 1 to 3 in its entirety merely for reasons of simplicity. The vehicle frame of the vehicle F can have a first longitudinal beam 1 and a second longitudinal beam 2. In addition, the vehicle frame of the vehicle F can have a first transverse beam 11 and a second transverse beam 12, which can be provided as parts of the support structure 10, for example.

The vehicle F can advantageously be embodied as an electric vehicle, wherein the fuel cell system 101 can provide electrical energy to an electric motor of the vehicle F.

It is further conceivable that the first transverse beam 11 and the second transverse beam 12 can each comprise at least one securing interface S1, S2 for securing the first transverse beam 11 and the second transverse beam 12 to the vehicle frame or a vehicle body part, in particular on the longitudinal beams 1, 2 of the vehicle F, preferably releasably, in particular in a form-fit or force-fit manner.

The above description of the figures describes the present invention solely in the context of examples. Of course, individual features of the embodiments can be freely combined with one another, insofar as technically sensible, without leaving the scope of the invention.

1. A fuel cell system (100) for a vehicle (F), comprising a vehicle frame or vehicle body part, having:
at least one fuel cell module (M1, M2) and a support structure (10) for supporting the fuel cell system (100) on the vehicle frame or the vehicle body part,
wherein the support structure (10) has at least one inner component support (13) relative to the at least one fuel cell module (M1, M2),
wherein submodules of the at least one fuel cell module (M1, M2) are connected to the at least one inner component support (13),
and wherein the at least one inner component support (13) has at least one securing interface (S3, S4) to secure the fuel cell system (100) on the vehicle frame or the vehicle body part.

2. The fuel cell system (100) according to claim 1,
wherein
the at least one inner component support (13) has only one continuous inner component support (13) relative to all fuel cell modules (M1, M2) to support the fuel cell system (101) with all fuel cell modules (M1, M2) simultaneously on the vehicle frame or the vehicle body part.

3. The fuel cell system (100) according to claim 2,
wherein
the continuous inner component support (13) has at least one connection point (N) between at least two modules (M1, M2) of the fuel cell system (101).

4. The fuel cell system (100) according to claim 1,
wherein
the at least one inner component support (13) has a single continuous inner component support (13) for each fuel cell module (M1, M2) of the fuel cell system (100) n to support the respective fuel cell module (M1, M2) of the fuel cell system (101) individually on the vehicle frame or the vehicle body part.

5. The fuel cell system (100) according to claim 1,
wherein
the at least one inner component support (13) is configured in one piece and/or materially uniform and/or monolithically,
or the at least one inner component support (13) is made of a plurality of parts that are connected to one another.

6. The fuel cell system (100) according to claim 1,
wherein
the at least one inner component support (13) has a profile that is closed in cross-section,
or the at least one inner component support (13) has a profile that is open in cross-section.

7. The fuel cell system (100) according to claim 1,
wherein
submodules (S, O, H, E, K) of the at least one fuel cell module (M1, M2) are releasably connected to the at least one inner component support (13).

8. The fuel cell system (100) according to claim 1,
wherein
the support structure (10) has a first transverse beam (11) and a second transverse beam (12) for supporting the at least one fuel cell module (M1, M2) respectively on a front and rear of the vehicle frame or on the vehicle body part,
wherein the at least one inner component support (13) is arranged so as to support the at least one fuel cell module (M1, M2) on the first transverse carrier (11) and on the second transverse carrier (12).

9. The fuel cell system (100) according to claim 8,
wherein
the first transverse beam (11) and the second transverse beam (12) each comprise at least one securing interface (S1, S2) for securing the first transverse beam (11) and the second transverse beam (12) to the vehicle frame or a vehicle body part.

10. A vehicle (F), having:
a vehicle frame or vehicle body part
and a fuel cell system (100) according to claim 1, which is supported on the vehicle frame or the vehicle body part.

11. The fuel cell system (100) according to claim 5, wherein the at least one inner component support (13) is made of a plurality of parts that are connected to one another in a materially locking manner by welding, or in a form-fit or force-fit manner by screwing, latching, and/or clamping.

12. The fuel cell system (100) according to claim 6, wherein the at least one inner component support (13) has a profile that is closed in cross-section and is O shaped.

13. The fuel cell system (100) according to claim 6, wherein the at least one inner component support (13) has a profile that is open in cross-section and is Z-shaped, T-shaped, C-shaped, or U-shaped.

14. The fuel cell system (100) according to claim 7, wherein the submodules (S, O, H, E, K) of the at least one fuel cell module (M1, M2) are releasably connected to the at least one inner component support (13) in a form-fit and/or force-fit manner.

15. The fuel cell system (100) according to claim 9, wherein the securing interface (S1, S2) for securing the first transverse beam (11) and the second transverse beam (12) to the vehicle frame or a vehicle body part releasably secures the first and second transverse beams in a form-fit or force-fit manner.
